(19) United States
(12) Patent Application Publication
(10) Pub. No.: US 2010/0308766 A1
(43) Pub. Date: Dec. 9, 2010

(54) Green Switch

(76) Inventor: Bruce Leroy Erickson, Monticello, MN (US)

Correspondence Address: BRUCE ERICKSON, 207 EAST FOURTH STREET, MONTICELLO, MN, 55362, US

(21) Appl. No.: 12/795,583

(22) Filed: Jun. 7, 2010

Related U.S. Application Data
(60) Provisional application No. 61/217,902, filed on Jun. 5, 2009.

(51) Int. Cl. H02J 7/00

(52) U.S. Cl. 320/107

(57) ABSTRACT

An energy saving device having a physical or electronic switch adapted to minimize energy use when not needed where the switch is securable to an adapter plug of an AC/DC power adapter. The switch includes an actuation button where attachment of a rechargeable device to the adapter plug allows electricity to flow from an electrical outlet through the physical or electronic switch and into the transformer of the AC/DC power adapter to allow for the charging of the rechargeable device and where removal of the rechargeable device from the adapter plug results in movement of the actuation button to interrupt the flow of electricity from the electrical outlet to the transformer of the AC/DC power adapter thereby preventing unnecessary power consumption by the AC/DC power adapter.

### REFERENCE TO RELATED APPLICATIONS

This patent application claims the benefit of U.S. Provisional Application No. 61/217,902 filed on Jun. 5, 2009, the disclosure of which is incorporated herein in its entirety by reference.

### BACKGROUND OF THE INVENTION

1. Field of the Invention

This invention relates generally to the prevention of unnecessary power consumption and, more specifically, to a battery charger and/or external power supply having a device that functions to connect and interrupt the flow of electricity to the battery charger and/or external power supply to help prevent unnecessary power consumption.

2. Description of Related Art

Circuits for monitoring and disconnecting a battery from a power charging circuit are known in the prior art. More specifically, by way of example, U.S. Pat. No. 7,119,459 to Bruwer, et al. discloses a switching circuit having a microchip which, in response to a signal from a signal switch, controls the operation of a power switch which, when closed, connects a load to a battery. The microchip monitors the status of the battery and controls the power switch to ensure operation of the load and usage of the energy in the battery.

U.S. Pat. No. 6,995,963 to Fadell, et al. discloses a power manager for managing power delivered to a battery operated peripheral device. The power manager includes an input current limiter to suppress a power surge. A voltage converter unit coupled to the input current limiter converts an external voltage to a supply voltage that is transmitted by a main bus to a voltage sensor unit. A comparator unit coupled to the voltage sensor sends a first switching signal to a switchover circuit that connects a peripheral device and an uncharged battery to the main bus having a supply voltage. When the battery is fully charged, the switchover circuit electrically disconnects the battery to prevent overcharge the battery.

U.S. Pat. No. 6,489,751 to Small, et al. discloses a battery charger which measures a voltage and a battery temperature and determines a rate of increase in battery temperature of a rechargeable battery pack. The battery charges to fast charge if the voltage and battery temperature indicate its safe and terminates the fast charge in response to the charge condition.

U.S. Pat. No. 6,271,605 to Carkner, et al. discloses a battery disconnect system having a switch which connects the battery to the load when the switch is in a closed state. The switch is also operative to disconnect the battery from the load when the switch is in an open state. The battery disconnect system also includes a switch controller that is coupled to the switch. The switch controller causes the switch to close in response to a first signal from a first external source. The switch controller also causes the switch to enter the open state in response to a second signal from a second external source.

U.S. Pat. No. 5,307,002 to Ho, et al. discloses a battery charging circuit which supplies a DC output from a mains supply for recharging a rechargeable battery, switch means in series with the battery across the DC output which are normally closed but which open from time to time to disconnect the battery from the DC output, battery voltage monitoring means for measuring the potential of the battery when the switch means are open, and means for determining a fully charged battery and decreasing the charging current from the DC output to the battery when the battery is fully charged.

### SUMMARY OF THE INVENTION

In an exemplary embodiment of the present invention, there is disclosed an energy saving device comprising:

adapter switch having a first end for supporting a transformer of an AC/DC power adapter therein and a second end for connection to an electrical outlet; and

a pushbutton switch connected to the adapter switch, the pushbutton switch securable to an adapter plug of the AC/DC power adapter,

the pushbutton switch including an actuation button located thereon;

wherein the attachment of a rechargeable device to the adapter plug results in the movement of the actuation button from a normally extended condition to a contacted condition to allow electricity to flow from an electrical outlet through the adapter switch and into the transformer of the AC/DC power adapter to allow for the charging of the rechargeable device and the removal of the rechargeable device from the adapter plug results in movement of the actuation button from the contacted condition to the normally extended condition to interrupt the flow of electricity from the electrical outlet to the transformer of the AC/DC power adapter thereby preventing unnecessary power consumption by the AC/DC power adapter.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows a side view of an embodiment of an adapter switch connectable to an external power supplies to prevent unnecessary power consumption;

FIG. 2 is a side view showing a cordless electrical toothbrush charger base having a plunger or push button switch to prevent unnecessary power consumption;

FIG. 3 shows a charger base for a battery pack of a cordless tool having a toggle switch for preventing unnecessary power consumption by the charger base;

FIG. 4 shows a battery pack being connected to the charger base of FIG. 3 for recharging; and

FIG. 5 shows a charger base for a battery pack of a cordless tool with the charger base having a magnetic reed switch for preventing unnecessary power consumption.

### DESCRIPTION OF THE PREFERRED EMBODIMENT

A growing number of household electrical devices are designed to draw power twenty-four hours a day, seven days a week. Even when turned off, some of these home electronics continue to use electricity. Battery chargers used for example by products such as cordless or cellular phones or external power supplies used for example by products such as laptops continue to draw power, even when the devices that they are charging are fully charged or have been disconnected. This electricity is wasted as heat which one can feel by simply touching the charger or external power supply when it is plugged in. The accumulation of power consumption of the aforementioned devices may result in up to 10 percent of the total electricity consumed by an average household. The aforementioned wasted power consumption not only wastes money, it also has a negative environmental impact.

Traditionally, the only way to guarantee that battery chargers or external power supplies are not drawing power is to either unplug the charger or external power supply from the electrical outlet or plug the charger or external power supply into a power strip and manually turn off the power strip. The problem with the aforementioned is that the user may forget to unplug the charger or external power supply from the electrical outlet or forget to manually turn off the power thereby leading to continual wasteful power consumption. Thus, there is a need for a device that will allow a battery charger and/or external power supply to continually be plugged into an electrical outlet while only consuming power when charging the device that it is connected thereto.

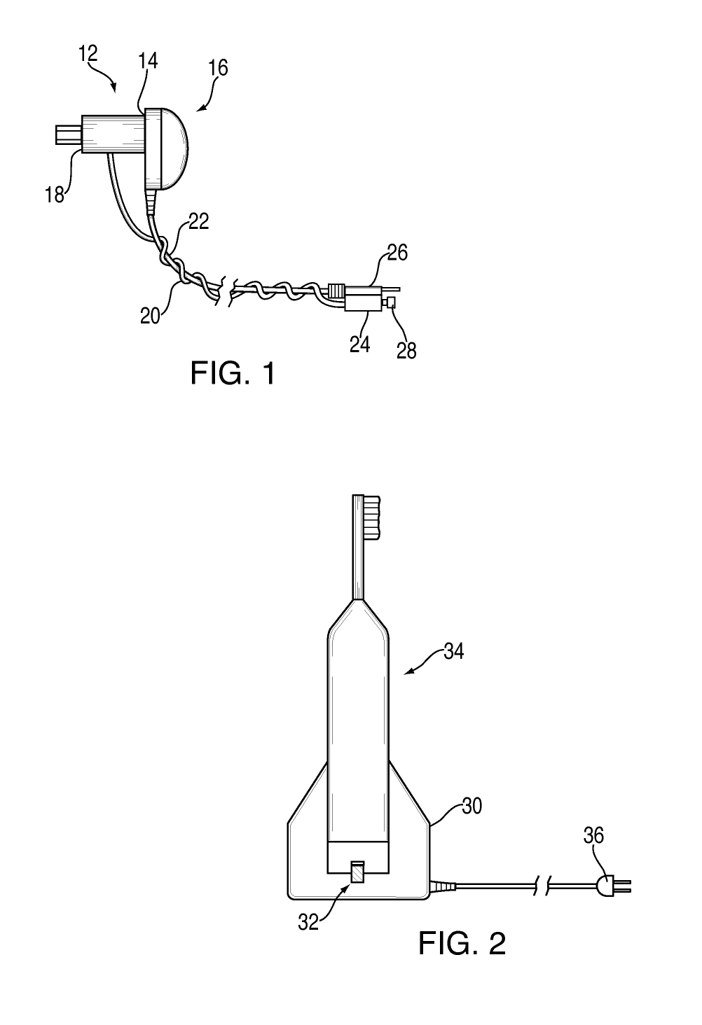

To solve the above problem of wasteful power consumption, FIG. 1 shows a side view of an embodiment of the present invention comprising an adapter switch 12 having a first end 14 for supporting a transformer of an AC/DC power adapter 16 therein and a second end 18 for connection to an electrical outlet. The adapter switch 12 includes an adapter switch electrical cable 20 shown wrapped around and running along a power adapter electrical cable 22 of the AC/DC power adapter and ending at a trigger switch 24. Trigger switch is shown attached to an adapter plug 26 of the AC/DC power adapter and comprises a form of a pushbutton-based switch 28.

Pushbutton switches are two-position devices actuated with a button that is pressed and released. Most pushbutton switches have an internal spring mechanism which returns the button to its normally extended or “unpressed,” state, for momentary operation. Some pushbutton switches will latch alternately on or off with every push of the button. Other pushbutton switches will stay in their contracted or “pressed” position until the button is pulled back out. The aforementioned types of pushbutton switches usually have a mushroom-shaped button for easy push-pull action.

The trigger switch of the embodiment of FIG. 1 is positioned with respect to the adapter plug such that a secured connection between the adapter plug and a rechargeable device such as but not limited to a laptop or cordless/cellular phone results in the actuation of the button located on the trigger switch from the normally extended or “unpressed” condition to a contracted or “pressed” condition.

A feature of the embodiment of FIG. 1 is that in the button's contracted or “pressed” condition, electricity is allowed to flow from the electrical outlet through the adapter switch and into the transformer of the AC/DC power adapter to allow for the charging of the rechargeable device. However, when the rechargeable device is disconnected from the adapter plug, the button of the trigger switch automatically returns back to its extended or “unpressed” condition, which causes the adapter switch to interrupt or cut off the flow of electricity from the electrical outlet to the transformer of the AC/DC power adapter thereby preventing unnecessary power consumption by the transformer of the AC/DC power adapter without the user having to manually unplug the AC/DC power adapter from the electrical outlet.

FIG. 2 is a side view showing an embodiment of a cordless electrical toothbrush charger base 30 having a plunger switch 32 which is based on the pushbutton switch. The plunger switch includes a button located on a charging surface of the electrical toothbrush charger base. The button of the plunger switch is normally in an extended or “unpressed” condition.

The placement of a cordless electrical toothbrush 34 within the cordless electrical toothbrush charger base for charging results in the actuation of the button from the normally extended or “unpressed” condition to a contracted or “pressed” condition. A feature of the embodiment of FIG. 2 is that in the button's contracted or “pressed” condition, electricity is allowed to flow from an electrical outlet through charger base electrical cord 36 and into the charger base to allow for the charging of the cordless electrical toothbrush. Similar to the switch of FIG. 1, the plunger switch of the cordless electrical toothbrush charger base includes an internal spring mechanism that operates to return the button of the plunger switch to an extended or “unpressed” condition upon the removal of the cordless electric toothbrush from the charger base.

The extended or “unpressed” condition of the button leads to a cut off or interruption in the flow of electricity from the electrical outlet to the electrical toothbrush charger base thereby preventing unnecessary power consumption by the electrical toothbrush charger base without the user having to manually unplug the electrical toothbrush charger base from an electrical outlet.

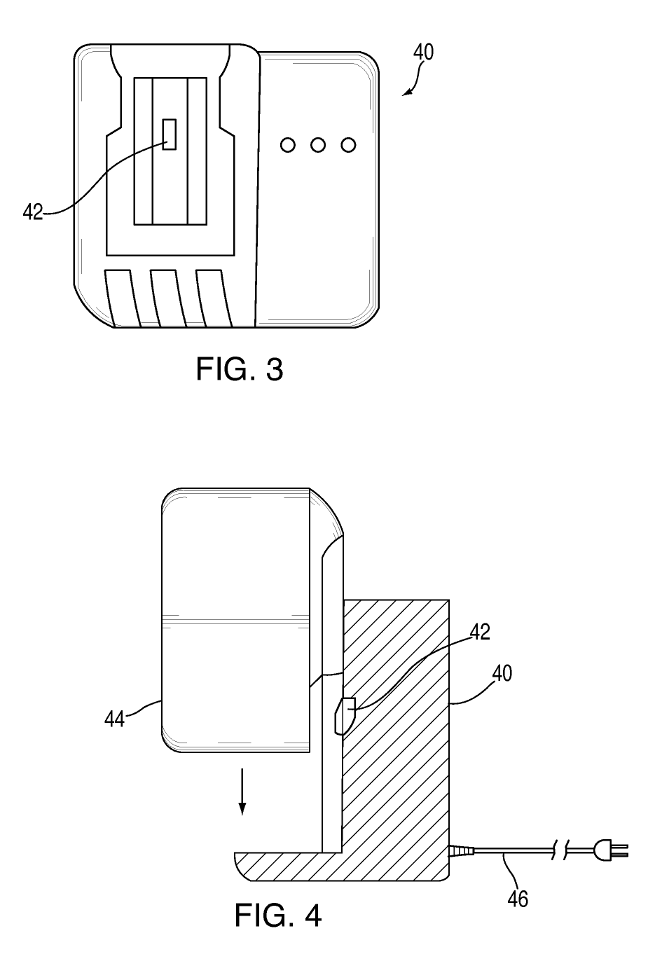

Referring to FIGS. 3 and 4, FIG. 3 shows an embodiment of a charger base 40 for a battery pack of a cordless tool with the charger base having a toggle switch 42 for preventing unnecessary power consumption by the charger base. FIG. 4 shows a battery pack 44 being attached to the charger base 40 for recharging.

The toggle switch is actuated by a lever angled in one of two or more positions. The toggle switch, such as the common light switch, may come to rest in any of its lever positions or alternatively has an internal spring mechanism which returns the lever to a certain normal position to allow for what is called “momentary” operation. The toggle switch 42 of FIG. 3 is actuated by a lever angled in a first off position, which interrupts the electrical flow in the circuit and a second on position which provides for the electrical flow in the circuit.

Referring to FIG. 4, the process of attaching the battery pack to the charger base for charging results in the actuation of the lever angled of the toggle switch from a normally first “off” position to a second “on” position. A feature of the embodiment of FIGS. 3 and 4 is that in the lever angle's second “on” position, electricity is allowed to flow from the electrical outlet through a charger base electrical cord 46 and into the charger base 40 to allow for the charging of the battery pack 44. Similar to the plunger or push button switch of the embodiment of FIG. 1, although not shown, the toggle switch of the embodiment of FIGS. 3 and 4 includes an internal spring mechanism that operates to return the lever back to the first “off” position upon the removal of the battery pack from the charge base. The first “off” position of the lever leads to a cut off or interruption in the flow of electricity from the electrical outlet to the charger base of FIGS. 3 and 4 thereby preventing unnecessary power consumption by the charger base without the user having to manually unplug the charger base from the electrical outlet.

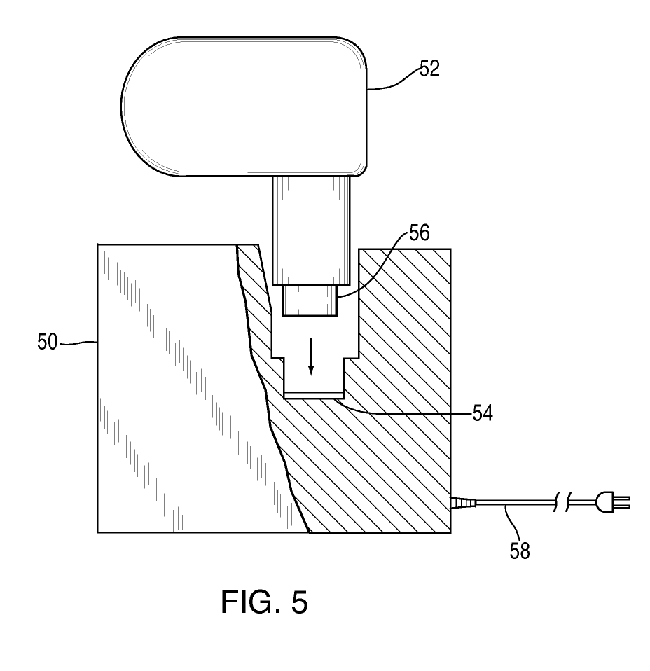

FIG. 5 shows an alternative embodiment of a charger base 50 for a battery pack 52 of a cordless tool with the charger base 50 having a magnetic reed switch 54 for preventing unnecessary power consumption by the charger base. Magnetic reed switch 54 is a specific example of what are generally known as proximity switches, which are generally switches that sense the approach of a metallic machine part either by a magnetic or high frequency electromagnetic field. Simple proximity switches typically use a permanent magnet to actuate a sealed switch mechanism whenever the machine part gets close, typically within 1 inch or less. More complex proximity switches work like a metal detector, namely energizing a coil of wire with a high-frequency current and then electronically monitoring the magnitude of that current. If a metallic part, not necessarily magnetic, gets sufficiently close to the coil, the current will increase and trip a monitoring circuit.

Alternatively, another form of a proximity switch is an optical switch, which comprises a light source and photocell in which machine position is detected by either the interruption or reflection of a light beam. Optical switches also useful in safety applications in which beams of light can be used to detect personnel entry into a dangerous area. In the embodiment of FIG. 5, the magnetic reed switch 54 is normally in an “off” condition and is actuated to an “on” condition by the proximity of a metallic machine part contained in an oncoming connection portion 56 of the battery pack. A feature of the embodiment of FIG. 5 is that in the “on” condition of the magnetic reed switch, electricity is allowed to flow from the electrical outlet through a charger base electrical cord 58 and into the charger base 50 to allow for the charging of the battery pack.

Upon the removal of the battery pack, and more specifically the metallic machine part of the connection portion of the battery pack, a sufficient distance from the magnetic reed switch of the charge base, the magnetic reed switch will actuate back to the “off” condition, which leads to a cut off or interruption in the flow of electricity from the electrical outlet to the charger base of FIG. 5 thereby preventing unnecessary power consumption by the charger base without the user having to manually unplug the charger base from the electrical outlet.

In further regards to the present invention, it is also noted that battery chargers or external power supplies having other devices that interrupt the flow of electricity to help prevent unnecessary power consumption by the battery charger or external power supply may also be used.

The present invention may also include a method for conserving electrical energy in the use of an electrical charger comprising the steps of (1) providing an electrical switch between the electrical charger and the electrical charger's source of electrical power and, (2) operating the electrical switch to close an electrical circuit between the electrical charger and the electrical charger's source of electrical power only when a chargeable device is coupled to the electrical charger.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. An energy saving device comprising:
adapter switch having a first end for supporting a transformer of an AC/DC power adapter therein and a second end for connection to an electrical outlet; and
a pushbutton switch connected to said adapter switch, said pushbutton switch securable to an adapter plug of said AC/DC power adapter; said pushbutton switch including an actuation button located thereon;
wherein the attachment of a rechargeable device to said adapter plug results in the movement of the actuation button from a normally extended condition to a contacted condition to allow electricity to flow from an electrical outlet through said adapter switch and into said transformer of said AC/DC power adapter to allow for the charging of the rechargeable device and the removal of said rechargeable device from said adapter plug results in movement of the actuation button from said contacted condition to said normally extended condition to interrupt the flow of electricity from said electrical outlet to said transformer of said AC/DC power adapter thereby preventing unnecessary power consumption by said AC/DC power adapter.

2. The device of claim 1 including an electric cable connecting said adapter switch to said pushbutton switch.

3. The device of claim 1 wherein said actuation button includes an internal spring mechanism for returning said actuation button from said contacted condition to said normally extended condition.

4. The device of claim 1 wherein said adapter switch is integrally formed to said AC/DC power adapter.

5. An energy saving device comprising:
a charger base having a switch located on a surface of the charger base wherein the attachment of a rechargeable device to said charger base results in the actuation of said switch from a normally off condition to an on condition to allow electricity to flow from an electrical outlet through said charger base allowing for the charging of said rechargeable device and the removal of said rechargeable device from said charger base results in the actuation of said switch from said on condition to said normally off condition to interrupt the flow of electricity from said electrical outlet to said charger base thereby preventing unnecessary power consumption by said charger base.

6. The device of claim 5 wherein said switch comprises a push button switch, said push button switch including a button located on said charging surface of said charger base wherein the attachment of said rechargeable device to said charger base results in the actuation of said button from said normally extended condition to said contacted condition to allow electricity to flow from said electrical outlet through said charger base allowing for the charging of said rechargeable device and the removal of said rechargeable device from said charger base results in the actuation of said button from said contacted condition to said normally extended condition to interrupt the flow of electricity from said electrical outlet to said charger base thereby preventing unnecessary power consumption by said charger base.

7. The device of claim 6 wherein said button includes an internal spring mechanism for returning said button from said contacted condition to said normally extended condition.

8. The device of claim 5 wherein said switch comprises a toggle switch.

9. The device of claim 5 wherein said switch comprises a proximity switch.

10. The device of claim 9 wherein said proximity switch comprises a magnetic read switch.

11. The device of claim 9 wherein said proximity switch comprises a optical switch.

12. The device of claim 5 wherein said rechargeable device comprises a battery pack.

13. The device of claim 5 wherein said rechargeable device comprises an electric toothbrush.

14. The device of claim 5 wherein said rechargeable device comprises a cellular phone.

15. The device of claim 5 wherein said rechargeable device comprises a cordless phone.

16. A device for conserving electricity comprising:
an adapter having an outlet electrically coupled to the electrical input of an electrical charger and an inlet electrically coupled to the output of an electrical power source for supplying charging energy to said charger;
an electrical switch connected to said adapter for opening and closing the electrical circuit between said adapter inlet and outlet; and
means for operatively coupling said switch to a chargeable device to close the electrical circuit only when the chargeable device is coupled thereto.

17. The device of claim 16 wherein the chargeable device comprises an electric car.

18. A method for conserving electrical energy in the use of an electrical charger comprising the steps of:
providing a physical or electronic switch between the electrical charger and the electrical charger's source of electrical power; and
operating the physical or electronic switch to close an electrical circuit between the electrical charger and the electrical charger's source of electrical power only when a chargeable device is coupled to the electrical charger.
